(19) United States
(12) Patent Application Publication
(10) Pub. No.: US 2021/0264671 A1
(43) Pub. Date: Aug. 26, 2021

(54) PANORAMIC AUGMENTED REALITY SYSTEM AND METHOD THEREOF

(71) Applicant: Uni-Well Entertainment Co., Ltd., New Taipei City (TW)

(72) Inventors: Yi-Chun Chen, New Taipei City (TW); Chung-Wei Hu, New Taipei City (TW); Hsiao-Ning Lai, New Taipei City (TW)

(21) Appl. No.: 16/995,789

(22) Filed: Aug. 17, 2020

(30) Foreign Application Priority Data
Feb. 21, 2020 (TW) 109105693

(51) Int. Cl. G06T 19/00; G06T 19/20; G09G 5/32; G06F 3/01; H04N 5/232; H04N 5/91; H04N 21/2187; H04N 21/81

(52) U.S. Cl. CPC G06T 19/006; G06T 19/003; G06T 19/20; G09G 5/32; H04N 5/2253; H04N 5/23238; H04N 5/91; H04N 21/2187; H04N 21/816; G06F 3/011

(57) ABSTRACT

The panoramic augmented reality system includes a panoramic camera device data-linked with a networked storage storing a panoramic image captured by panoramic camera device. The networked storage is connected by at least an electronic device which includes an APP, an AR module, and at least an image adjustment module. To produce live streaming, the panoramic camera device is set up in the scene and the panoramic image captured by the panoramic camera device is stored in the networked storage. The panoramic image is then accessed through the APP and a 3D space is created together with the AR module. A display image corresponding to the user's position and direction in the 3D space is created and continuously updated based on the image adjustment module's detection. Therefore, the user may navigate the 3D space as if he/she is actually present in the scene, creating a realistic experience.

### BACKGROUND OF THE INVENTION

### (a) Technical Field of the Invention

The present invention is generally related to augmented reality, and more particular to a panoramic augmented reality system and a related method.

### (b) Description of the Prior Art

Due to the wide popularity of on-line video platforms, live streaming is a new form of entertainment where events, usually hosted by the so-called broadcaster or streamer, are broadcast in real time. The greatest difference between live streaming and the streaming of pre-recorded video lies in that users are able to talk to or participate in conversation or interaction with the streamer.

Live streaming is usually achieved through a camera capturing the streamer's computer screen. As the technology advanced, there are more diversified ways to shooting a scene. One example is through virtual reality (VR) techniques so that a 3D environment is simulated. However, this requires multiple cameras shooting from different angles, which is costlier both in terms of production and broadcasting.

In addition, VR systems usually require VR headsets to produce realistic images and to simulate a user's presence in the virtual environment. Therefore, it is more demanding in terms of user equipment and environment. If the 360-degree panoramic image is used, the image can only be read and turned/scaled by sliding, thereby failing to produce a realistic effect.

### SUMMARY OF THE INVENTION

A major objective of the present invention is to employ an AR module to process a panoramic image to create a 3D space, and to generate a display image for the 3D space by an image adjustment module so as to provide a convenient and realistic live streaming viewing environment.

To achieve the objective, the panoramic augmented reality system includes at least a panoramic camera device, a networked storage data-linked with the panoramic camera device, at least an electronic device connected to the networked storage, an APP configured in the electronic device, an AR module configured in the electronic device, and at least an image adjustment module configured in the electronic device.

As described above, one or more panoramic camera devices are placed in a scene and, through the panoramic camera devices, the scene is captured into a panoramic image which is stored in the networked storage. When a user intends to view the live streaming of the scene, he/she accesses the panoramic image by using the APP in his/her electronic device to connect the networked storage. The panoramic image is then processed by the AR module to create a 3D space corresponding to the scene. The user's position and direction in the virtual 3D is determined by the image adjustment module and a display image corresponding to the user's perspective is shown in the electronic device. When the user physically moves in his/her real environment, the image adjustment module detects this movement and direction and produces an updated display image, together with the AR module on the electronic device. As such, using his/her electronic device, the user may navigate the 3D space as if he/she is actually present in the scene, thereby achieving realistic view experience.

Through the above-described system, the problem of prior art that the panoramic image is difficult to utilize is obviated.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a first embodiment of the present invention.

FIG. 2 is a functional block diagram showing the first embodiment of the present invention of FIG. 1.

FIG. 3 is a flow diagram showing a related method of the present invention.

FIGS. 4 to 8 show an application scenario of the first embodiment of the present invention of FIG. 1.

FIGS. 9 to 11 show an application scenario of a second embodiment of the present invention.

FIG. 12 is a perspective diagram showing a third embodiment of the present invention.

FIG. 13 is a functional block diagram showing the third embodiment of the present invention of FIG. 12.

FIGS. 14 to 16 show an application scenario of the third embodiment of the present invention of FIG. 12.

FIG. 17 is a perspective diagram showing a fourth embodiment of the present invention.

FIGS. 18 to 20 show an application scenario of the fourth embodiment of the present invention of FIG. 17.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

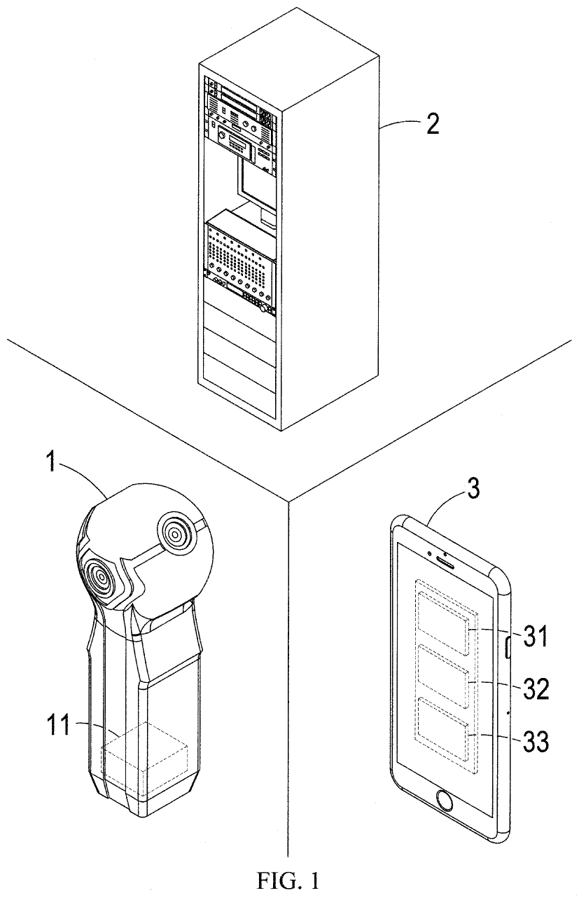

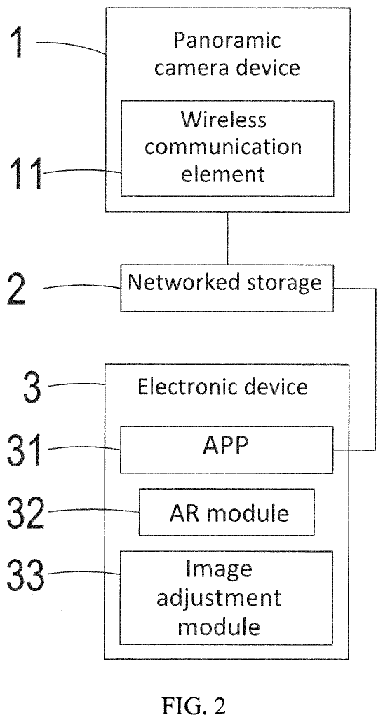

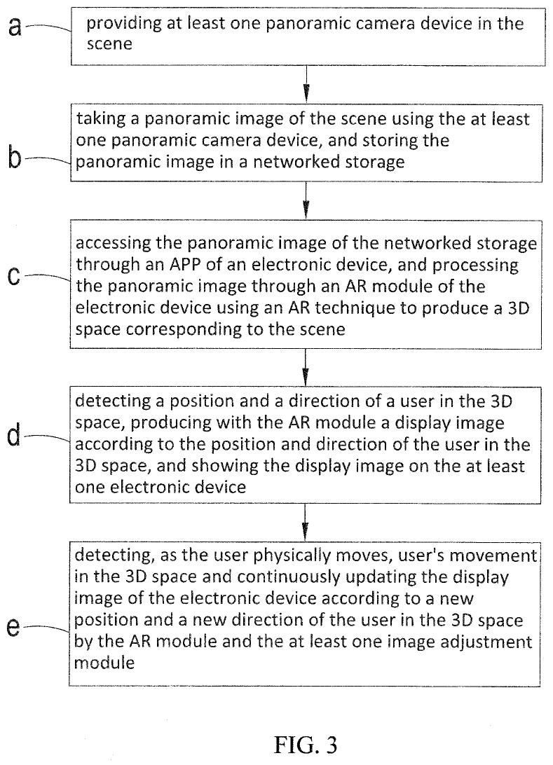

As shown in FIGS. 1 to 8, an embodiment of the present invention includes the following components.

There is at least a panoramic camera device 1 which, in the present embodiment, is a 360-degree camera.

A networked storage 2 is data-linked with panoramic camera device 1 where at least a panoramic image captured by the panoramic camera device 1 may be stored. In the present embodiment, the networked storage 2 is a network server and the panoramic camera device 1 includes a wireless communication element 11 such as a wireless antenna through which the panoramic image is transmitted to the networked storage 2.

At least an electronic device 3 is, for example, one of a mobile phone and a tablet computer. Inside the electronic device 3, there is an application program (APP) 31 capable of accessing the networked storage 2.

Inside the electronic device 3, there is also an AR (Augmented Reality) module 32 that may be the ARKit, ARcore, or similar package. The AR module 32 processes the panoramic image using AR technique.

The electronic device 3 also includes an image adjustment module 33 that in turn may include a gyroscope or a GPS positioning device. The present embodiment use gyroscope as an example.

The structure of the panoramic augmented reality system is described above. Its operation of explained as follows.

A method of the panoramic augmented reality system includes the following steps:

(a) providing at least a panoramic camera device in a scene;

(b) taking a panoramic image of the scene using the panoramic camera device, and storing the panoramic image in a networked storage;

(c) accessing the panoramic image of the networked storage through an APP of an electronic device, and processing the panoramic image through an AR module of the electronic device to produce a 3D space;

(d) detecting a location and a direction of a display image of the electronic device in the 3D space through an image adjustment module and the AR module of the electronic device; and

(e) continuously calculating and updating the display image in the 3D space by the image adjustment module, along with the AR module, when the image adjustment module detects that the display image has moved within the 3D space.

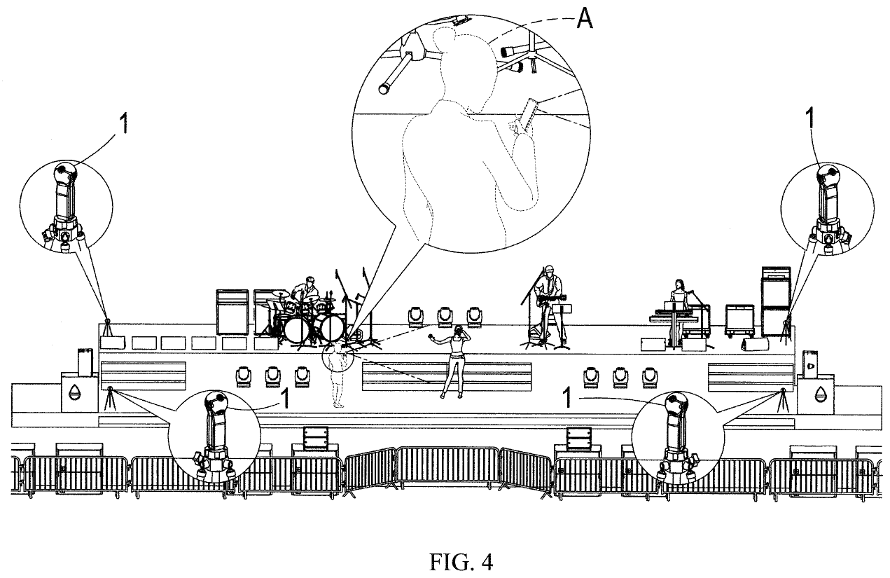

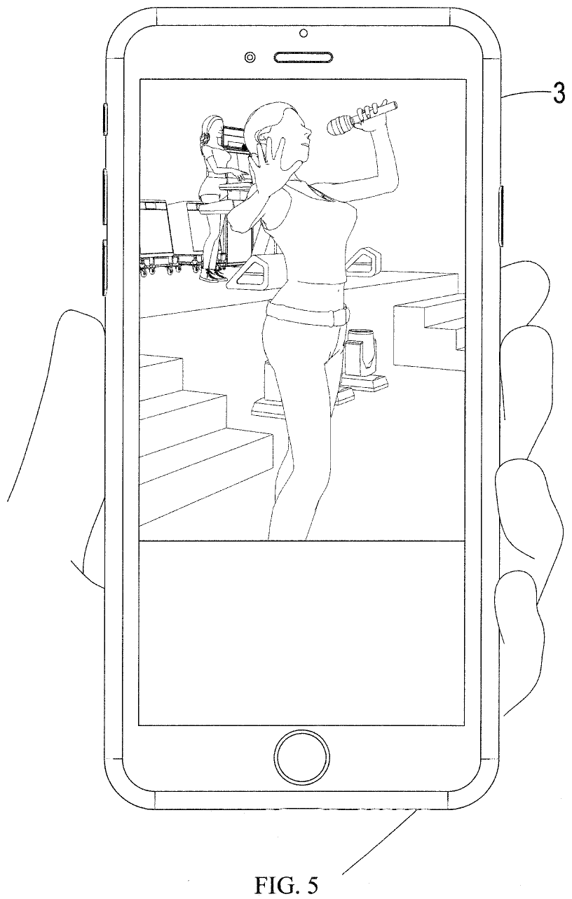

According to the above method, the panoramic camera device 1 may be applied to various scenes. For example, as shown in FIG. 4, the present embodiment is applied to live streaming the scene of a concert using multiple panoramic camera devices 1 positioned at various locations of the concert stage. Since the panoramic camera devices 1, compared to ordinary cameras, capture a wider angle and a few panoramic camera devices 1 are able to create a panoramic image covering the entire stage. The panoramic image is then delivered to the networked storage 2 through the wireless communication element 11. A user, through APP 31 in his/her electronic device 3 (for example, a mobile phone in the present embodiment) connects to the networked storage 2 and accesses the panoramic image. The AR module 32 in the mobile phone processes the panoramic image using AR techniques, thereby producing a 3D space corresponding to the scene. In the meantime, the image adjustment module 33 detects the user's location within the 3D space and, together with the AR module 32, produces a display image which the user may perceive if he/she is positioned at the specific location in the 3D space. The display image is then presented on the electronic device 3. For example, a user A is assumed to be located on the stage as shown in FIG. 4, the AR module 32 and the image adjustment module 33 then produce a corresponding display image shown on the electronic device 3 as shown in FIG. 5.

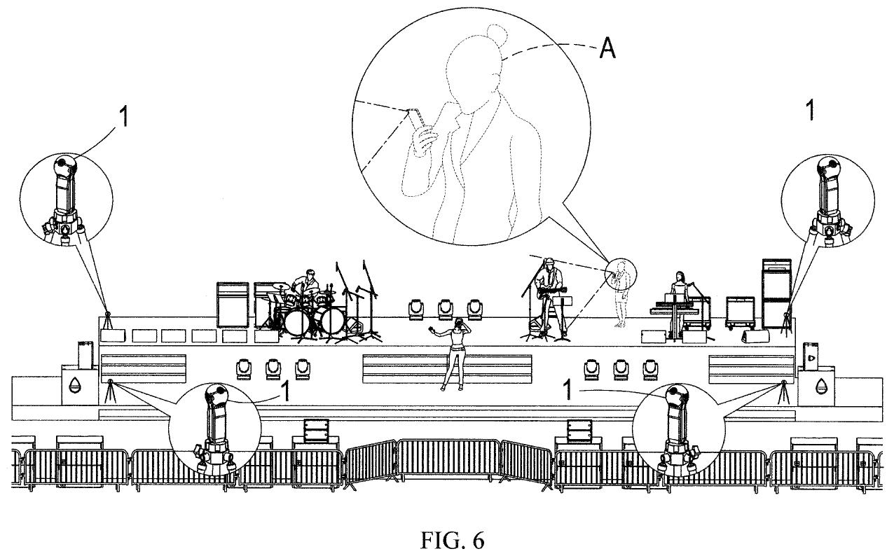

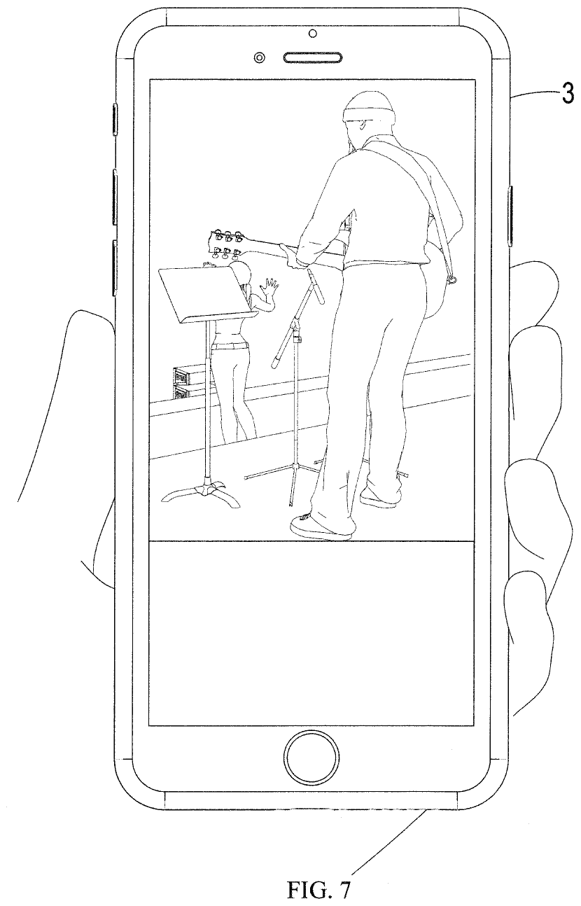

If the user A moves in his/her own real space, the image adjustment module 33 detects the distance, direction, and destination of this movement, and continuously adjusts and updates the display image on the electronic device 3. For example, if the user moves within his/her environment so that his/her corresponding location in the 3D space has changed to the location as shown in FIG. 6, a corresponding display image reflecting what would be viewed by the user A at that location on the stage is shown in the electronic device 3 as shown in FIG. 7. As such, the user A would have a realistic perception as if he/she is really present at the scene and the user may change his/her perspective by moving around.

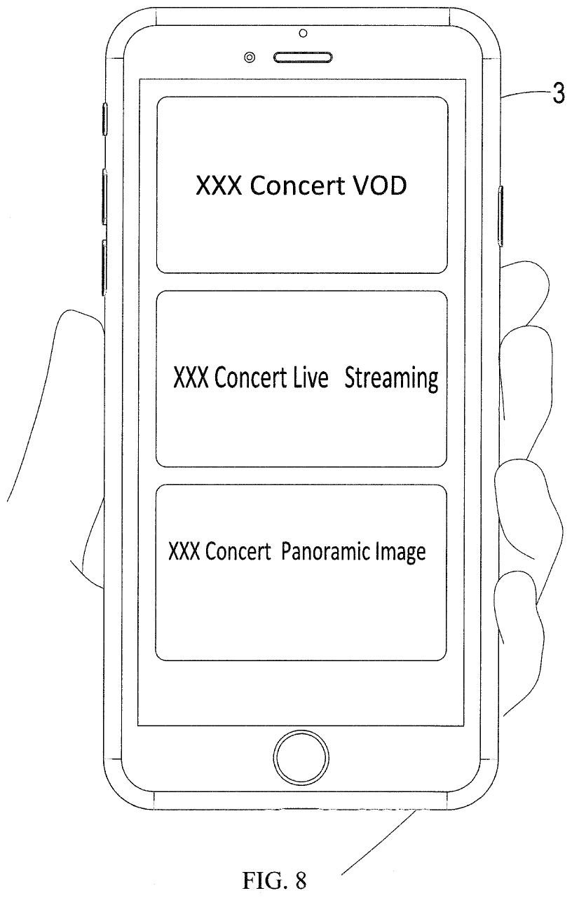

According to the present invention, the panoramic image is processed using an AR technique to produce a 3D space. Then, through the image adjustment module 33, a user may move around in this 3D space where a corresponding display image is constantly updated accordingly. It is well known that AR techniques generally all process pictures or images based on distance and direction calculations to produce 3D space. The existing approaches are to deliver a 3D stereographic picture (i.e., display image) to a mobile phone and a user views this image using the mobile phone's photo viewing function such as zooming in or out, or moving an object into the center of the screen as if it is in front of the user by sliding the image. The present invention's approach is different in that the display image is continuously updated on the electronic device through the image adjustment module 33 and the AR module 32 as the user physically moves around. A user then would feel like he/she is moving in the 3D space reflecting the shooting scene and he/she is walking to face the object. The present invention, in the meantime, would changes in the display image the relative distances and directions of various objects within the 3D space as the user shifts his/her perspective. As shown in FIGS. 4 to 7, the user's perspective would be different if he/she is positioned differently. In contrast to VR techniques, the present invention does not require any head gears and may achieve the same 3D viewing effect under a more simplified condition using the AR module 32 and the image adjustment module 33 of the electronic device 3. As shown in FIG. 8, after the live streaming is over, recording and the panoramic image may be reserved in the networked storage 2, showing something like “XXX Concert VOD,” “XXX Concert Live Streaming,” and “XXX Concert Panoramic Image” on the electronic device 3, so that users who miss the live streaming may access the VOD or the static panoramic image afterwards.

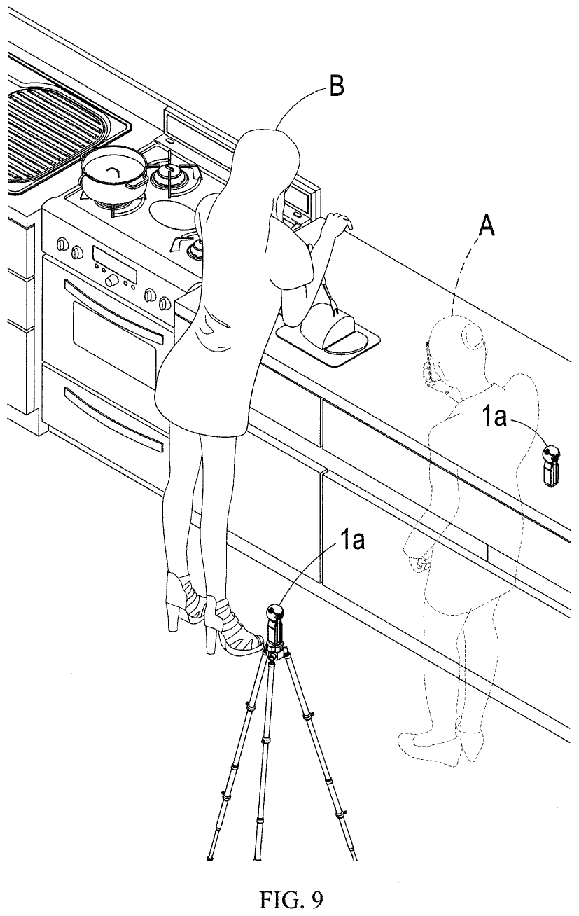

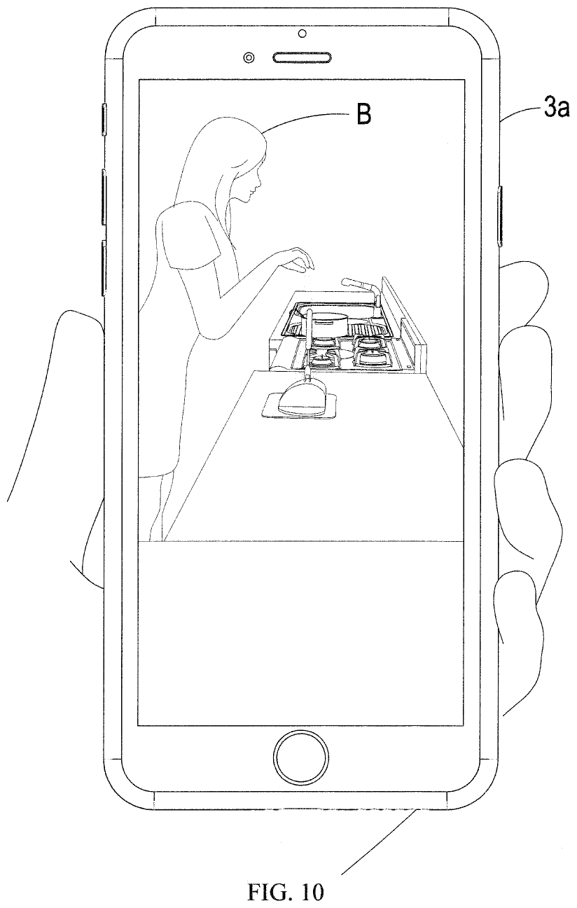

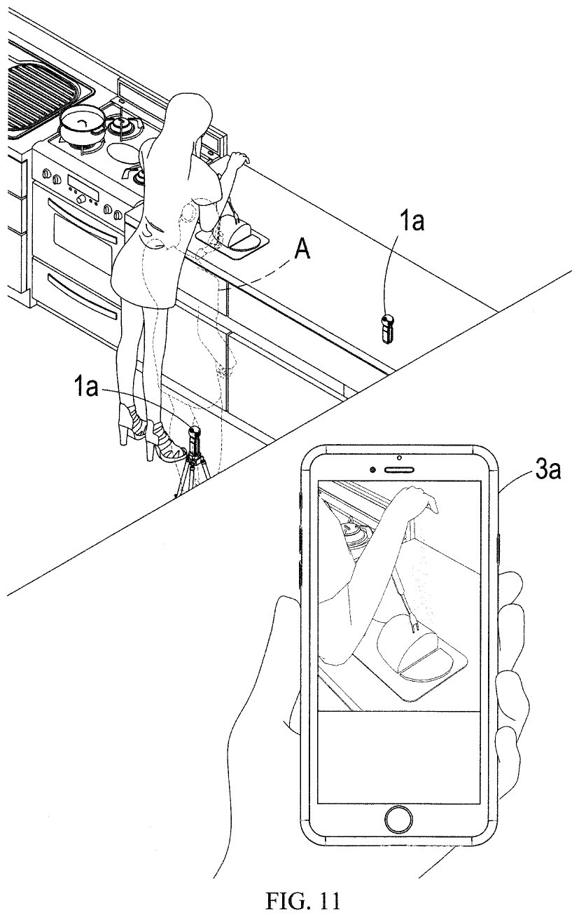

As shown in FIGS. 9 to 12, in another shooting scene for teaching cooking, a number of panoramic camera devices 1a are placed around a cook B to capture the cook B's various activities from different perspectives. A user A then may move around in the 3D space created from the panoramic image captured by the panoramic camera devices 1a and view the cook A's operations from different angles through the display images on his/her electronic device 3a, thereby fully learning cook B's various techniques.

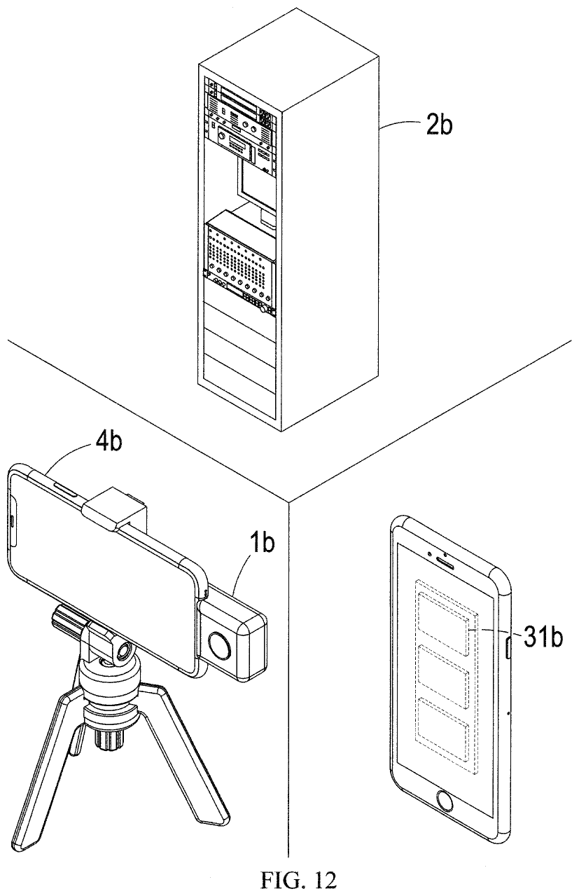

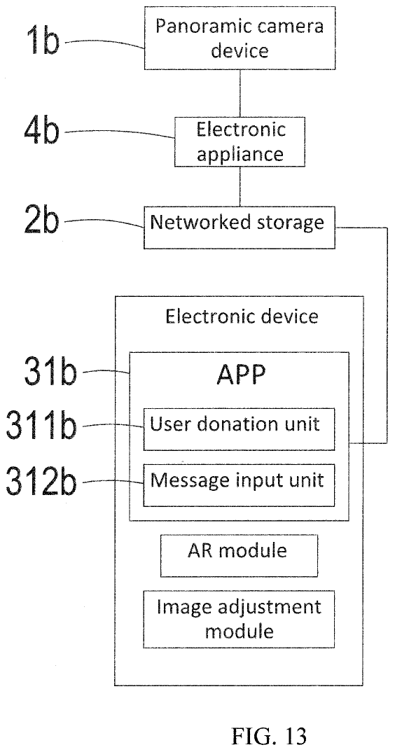

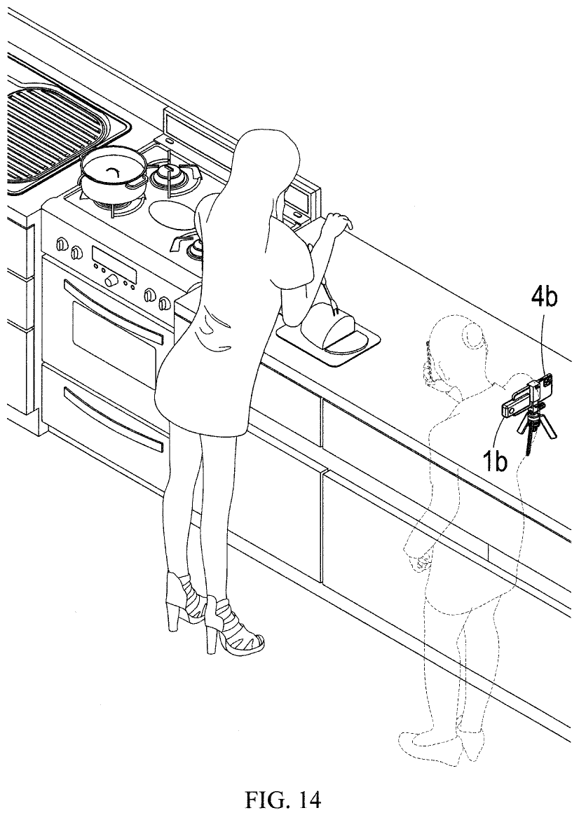

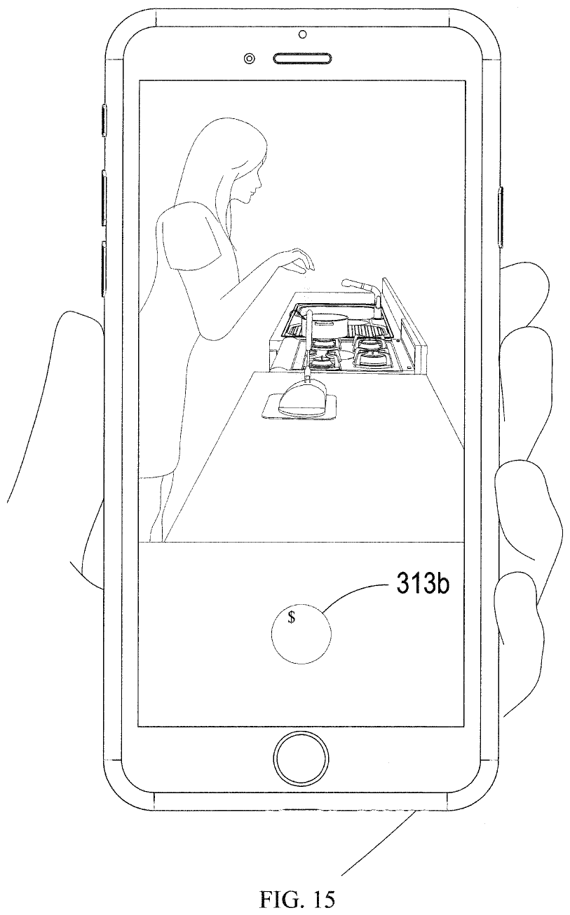

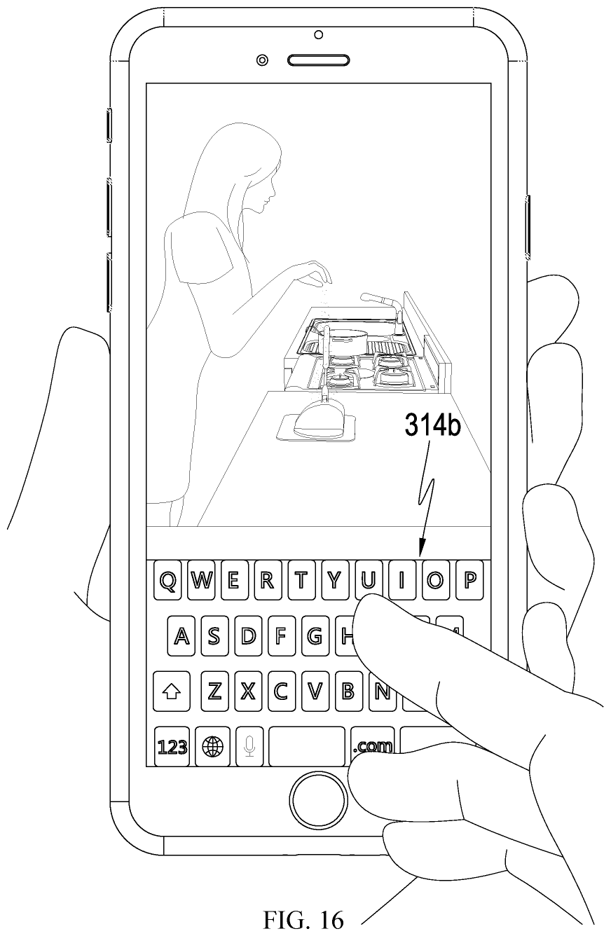

As shown in FIGS. 12 to 16, the present invention is applied in the same shooting scene but the panoramic camera device 1b is a 360-degree camera mounted on an electronic appliance such as a mobile phone 4b where the captured panoramic image is delivered to the networked storage 2b by the mobile phone 4b.

In the present embodiment, the APP 31b further provides a user donation unit 311b and a message input unit 312b through which a user may interact with the streamer. For example, the user may click a donation icon 313b shown by the user donation unit 311b and make donation to the streamer by transfer through credit card or on-line banking system. The user also may raise question by inputting text in a dialog window 314b of the message input unit 312b and the steamer may see the message on the mobile phone 4b, thereby greatly enhancing the interactivity and fun of live streaming.

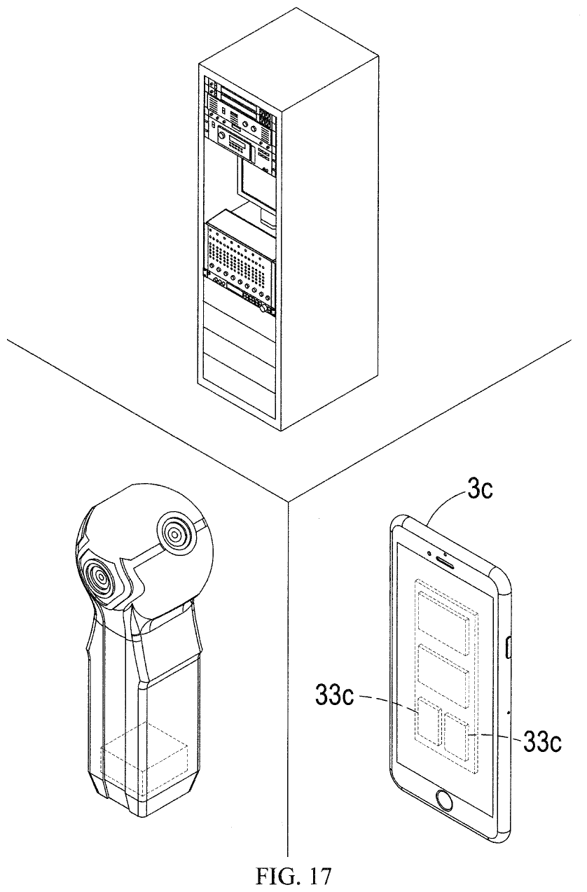

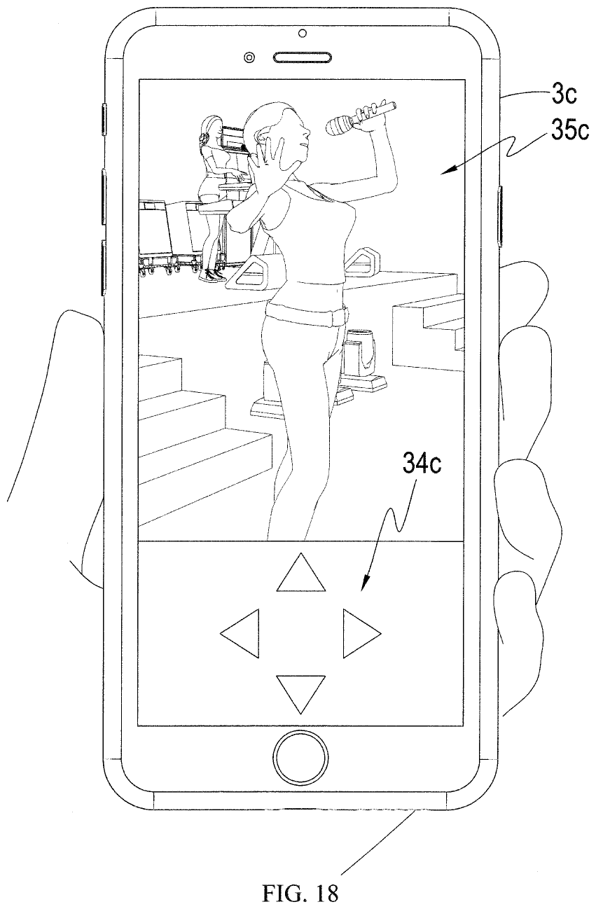

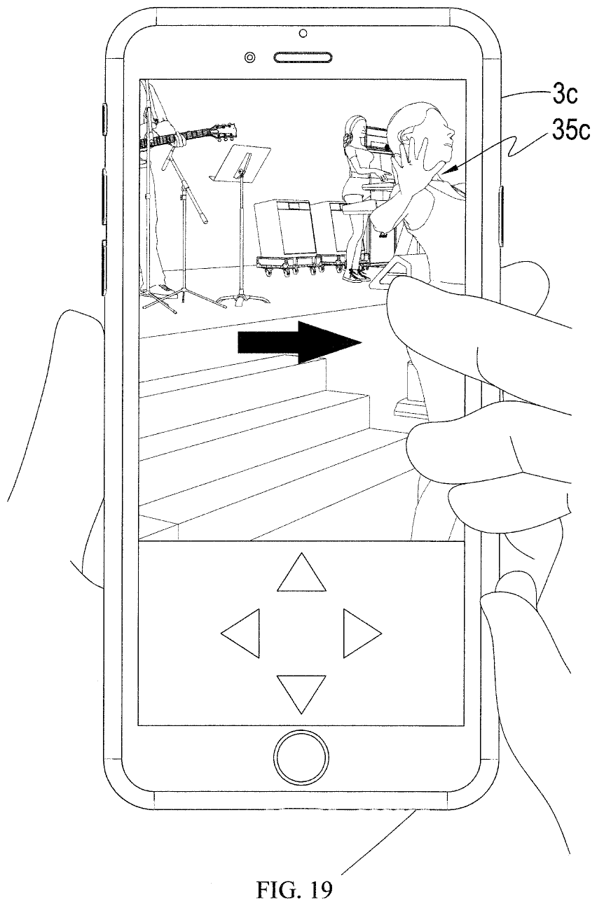

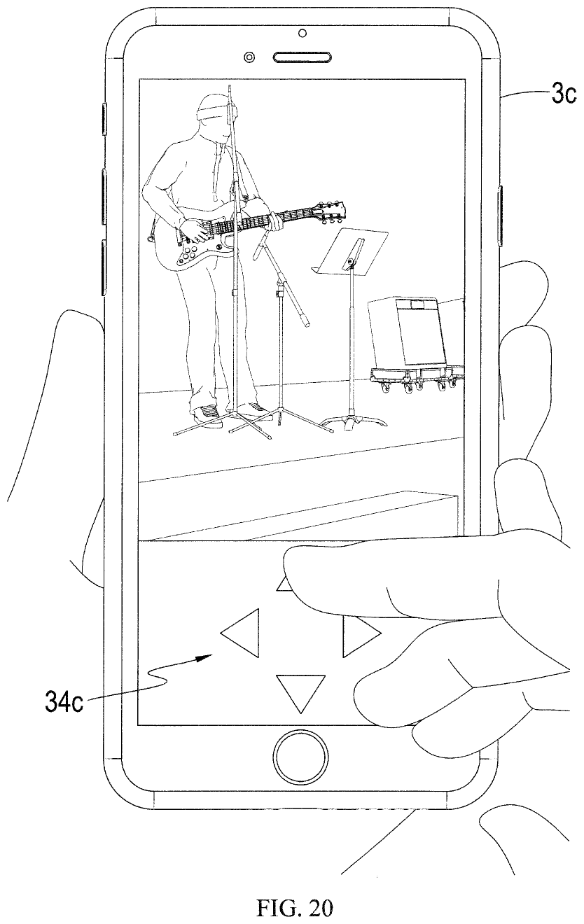

As shown in FIGS. 17 to 20, in the present embodiment, there are two image adjustment modules 33c, a gyroscope for sensing the electronic device 3c's movement and direction and a control module for receiving control signals. In the present embodiment, the control module provides directional keys 34c and a slidable screen 35c electronic device 3c. These are exemplary and the present invention is not limited as such. The electronic device 3c is a mobile phone in the present embodiment but it may also be a non-portable screen such as TV or computer display. As such, when the user does not have enough room for his/her movement, the user may still virtually move in the 3D space and adjust the display image by operating the control module. As shown in FIGS. 19 and 20, when the user reaches a location that he/she is not able to move further, the user may slide the slidable screen 35c to change viewing angle or press the directional keys 34c to move beyond physical constraint, thereby greatly enhancing the convenience of the present invention.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A panoramic augmented reality system for live streaming a scene, comprising:
at least one panoramic camera device positioned in the scene;
a networked storage data-linked with the at least one panoramic camera device for receiving a panoramic image captured by the at least one panoramic camera device;
at least one electronic device connected to the networked storage;
an APP configured in the at least one electronic device for accessing the panoramic image;
an AR (Augmented Reality) module configured in the at least one electronic device for processing panoramic image using AR technique to produce a 3D space corresponding to the scene; and
at least one image adjustment module configured in the electronic device that detects a position and a direction of a user of the at least one electronic device, produces with the AR module a display image according to the position and direction of the user in the 3D space, and shows the display image on the at least one electronic device, where, when the user physically moves, the at least one image adjustment module detects the user's movement in the 3D space and continuously updates the display image according to a new position and a new direction of the user in the 3D space with the AR module.

2. The panoramic augmented reality system according to claim 1, wherein the at least one image adjustment module comprises a control module and receives a control signal from the control module.

3. The panoramic augmented reality system according to claim 1, wherein the networked storage further stores a recording of the live streaming of the scene.

4. The panoramic augmented reality system according to claim 1, wherein the at least one panoramic camera device is mounted on an electronic appliance.

5. The panoramic augmented reality system according to claim 1, wherein the APP comprises a user donation unit for the user to make donation and a message input unit for the user to enter text.

6. A panoramic augmented reality method for live streaming of a scene, comprising:
(a) providing at least one panoramic camera device in the scene;
(b) taking a panoramic image of the scene using the at least one panoramic camera device, and storing the panoramic image in a networked storage;
(c) accessing the panoramic image of the networked storage through an APP of an electronic device, and processing the panoramic image through an AR module of the electronic device using an AR technique to produce a 3D space corresponding to the scene;
(d) detecting a position and a direction of a user in the 3D space, producing with the AR module a display image according to the position and direction of the user in the 3D space, and showing the display image on the at least one electronic device; and
(e) detecting, as the user physically moves, user's movement in the 3D space and continuously updating the display image of the electronic device according to a new position and a new direction of the user in the 3D space by the AR module and the at least one image adjustment module.

7. The panoramic augmented reality method according to claim 6, wherein the at least one image adjustment module comprises a control module and receives a control signal from the control module.

8. The panoramic augmented reality method according to claim 6, wherein the networked storage further stores a recording of the live streaming of the scene.

9. The panoramic augmented reality method according to claim 6, wherein the at least one panoramic camera device is mounted on an electronic appliance.

10. The panoramic augmented reality method according to claim 6, wherein the APP comprises a user donation unit for the user to make donation and a message input unit for the user to enter text.
